(19) United States
(12) Patent Application Publication
(10) Pub. No.: US 2020/0361474 A1
(43) Pub. Date: Nov. 19, 2020

(54) ELECTRIC VEHICLE

(71) Applicant: Hyan Soo YEO, Seoul (KR)

(72) Inventor: Hyan Soo YEO, Seoul (KR)

(21) Appl. No.: 16/835,272

(22) Filed: Mar. 30, 2020

(30) Foreign Application Priority Data
May 15, 2019 (KR) 10-2019-0057087

(51) Int. Cl. B60W 30/19; B60W 10/10; B60W 10/08

(52) U.S. Cl. CPC B60W 30/19; B60W 10/08; B60W 10/10

(57) ABSTRACT

Disclosed herein is an electric vehicle equipped with a battery. The electric vehicle includes: a first gear shifting unit configured to allow gear shifting for a low speed to be performed; a second gear shifting unit configured to allow gear shifting for a high speed to be performed; and a rotation shaft configured to be rotated by the driving of the first and second gear shifting units. The first gear shifting unit includes a first drive gear unit and a second drive gear unit. The first drive gear unit includes a first gear, a first motor, a second gear, a second motor, a third gear, and a third motor. The second drive gear unit includes a fourth motor, and a fifth motor.

### CROSS-REFERENCE TO RELATED APPLICATION

This application claims the benefit of Korean Patent Application No. 10-2019-0057087 filed on May 15, 2019, which is hereby incorporated by reference herein in its entirety.

### BACKGROUND

### 1. Technical Field

The present invention relates generally to an electric vehicle, and more particularly to an electric vehicle that allows gear shifting to be performed according to the driving of motors connected to a battery and can travel for a long time using power generated by a power supply unit.

### 2. Description of the Related Art

Generally, research is being actively carried out in that electric vehicles are the most likely alternatives that can solve automobile pollution and energy problems in the future.

Electric vehicles (EVs) are vehicles that mainly obtain power by driving an alternating current (AC) or direct current (DC) motor using the power of a battery. Electric vehicles are basically classified into battery-only electric vehicles (fully-EVs, or plug-in EVs) and hybrid electric vehicles. Battery-only electric vehicles use the power of a battery to drive a motor, and are recharged when the power is exhausted. In contrast, hybrid electric vehicles generate electricity by operating an engine, charge a battery with the electricity, and drive an electric motor using the electricity of the battery, thereby moving the vehicles themselves.

Furthermore, hybrid electric vehicles may be classified into series-type electric vehicles and parallel-type electric vehicles. In series-type electric vehicles, mechanical energy output from an engine is converted into electrical energy through a generator, the electrical energy is supplied to a battery or motor, and thus the vehicle is always driven by the motor. Series-type electric vehicles are based on the concept that an engine and a generator are added to a conventional electric vehicle in order to increase mileage. In contrast, in parallel-type electric vehicles, two power sources are used such that a vehicle may be moved only by battery power and the vehicle may be driven only by an engine (a gasoline or diesel engine), and the engine and the motor may simultaneously drive the vehicle according to driving conditions.

Furthermore, with the recent development of motor/control technologies, a high-output, small-size, high-efficiency system has been developed. As a DC motor has been converted into an AC motor, the output and power performance (acceleration performance and maximum speed) of an electric vehicle has been considerably improved, thus reaching a level comparable to that of a gasoline vehicle. As high rotation has been performed in pursuit of high output, a motor has become lighter and smaller, and the loading weight and volume have been considerably reduced.

Meanwhile, even in conventional vehicles, a small battery is used to operate a load inside electric equipment, or the energy of the small battery is used when a vehicle is started. In the case of electric vehicles, the energy of a high-voltage battery for the operation of a vehicle and the energy of an auxiliary battery for the operation of a load inside electric equipment are used.

In this case, when an ignition is turned off and thus a vehicle enters a non-operational state, a leakage current may be generated from an auxiliary battery to a load inside electric equipment, and the auxiliary battery is discharged or falls to a low voltage when current may continuously leak. Furthermore, when the discharge end voltage of the auxiliary battery is reached, the auxiliary battery can no longer be used, affecting the life of the auxiliary battery.

Vehicles are required to operate under the sway of various external environments, such as high-speed driving, low-speed driving, and parking movement, and drivers safely drive the vehicles without any accident by controlling the vehicles while actively responding to those various external environments.

However, if the safety of vehicles is entirely dependent on the driving ability and situation handling ability of individual drivers, the accessibility of unskilled drivers to vehicles that are considered to be daily necessities is limited.

Therefore, various vehicle control technologies based on advanced electronic and control technologies are applied to vehicles in order to ensure safe driving without active driver action, thereby increasing the accessibility of unskilled drivers to vehicles and also increasing the control convenience of proficient drivers.

Generally, vehicles to which the above-described various vehicle control technologies are applied are referred to as smart vehicles.

Examples of vehicle control technologies applied to smart vehicles include Advanced Smart Cruise Control (ASCC), Advanced Emergency Braking System (AEBS), Hill Start Assist (HSA), Hill Descent Control (HDC), Smart Parking Assist System (SPAS), and Parking Assist System (PAS).

The Advanced Smart Cruise Control (ASCC) is a function that ensures safety by maintaining the distance between a preceding vehicle and a vehicle while automatically maintaining traveling speed without a driver's pedal operation.

The Advanced Emergency Braking System (AEBS) is a function that securely ensures an inter-vehicle distance to a preceding vehicle without a driver's operation during driving.

The Hill Start Assist (HAS) is a function that ensures safety by preventing slipping when starting after stopping on an uphill road, and the Hill Descent Control (HDC) is a function that ensures safety by smoothly performing downhill driving on a steep slope.

The Smart Parking Assist System (SPAS) is a convenient rear parking function without the shifting of a shift lever during parking, and Parking Assist System (PAS) is a rear parking function that quickly responds to the accidental emergence of an obstacle.

In the following description, the Advanced Smart Cruise Control is referred to as the ASCC, the Advanced Emergency Braking System is referred to as the AEBS, the Hill Start Assist is referred to as the HSA, the Hill Descent Control is referred to as the HDC, the Smart Parking Assist System is referred to as the SPAS, and the Parking Assist System is referred to as the PAS.

However, smart functions, such as the ASCC, the AEBS, the HSA, the HDC, the SPAS and the PAS, need to be specialized to be cooperatively controlled in association with electronic devices related to the operation of a vehicle in order to be applied to the actual vehicle. This aspect significantly limits the applicability of electric vehicles, which are currently emerging as eco-friendly vehicles, as actual vehicles.

The main reason for this is that electric vehicles have no transmission, unlike internal combustion engine-type vehicles.

For example, when a shift lever is operated to change a traveling speed, the operation of the shift lever in an internal combustion engine-type vehicle results in the gear shifting of a transmission while the operation of the shift lever in an electric vehicle results in motor torque conversion, not the gear shifting of a transmission.

Accordingly, in order for electric vehicles to be developed into and commercialized as smart electric vehicles, ASCC, AEBS, HSA, HDC, SPAS, PAS, etc. need to be specialized to be associated with a motor, i.e., a power source, and particularly it is inevitable to develop technology that can optimize the torque control of the motor according to a smart function.

For example, Korean Unexamined Patent Application No. 10-2013-0130217 discloses an “electric vehicle and a method for charging the auxiliary battery thereof.”

The electric vehicle disclosed in Korean Unexamined Patent Application No. 10-2013-0130217 is provided with a high-voltage battery configured to generate driving energy, and includes: an auxiliary battery configured to supply power to pieces of electric equipment provided in the electric vehicle; a first battery management unit (BMU) configured to manage the state of the high-voltage battery; a voltage adjustment unit configured to charge the auxiliary battery using the high-voltage battery; a second BMU configured to manage the state of the auxiliary battery; a relay configured to operate in conjunction with the second BMU via electrical signals and to control current to be supplied to the electric equipment; and a terminal configured to receive details of the high-voltage battery and the auxiliary battery in real time by using a communication medium provided in the second battery control unit.

Korean Unexamined Patent Application No. 10-2013-0142349 discloses a “smart electric vehicle and a method for operating the same.”

The smart electric vehicle disclosed in Korean Unexamined Patent Application No. 10-2013-0142349 includes: a motor configured to generate power using battery power; a motor control unit (MCU) configured to control the motor; an anti-lock braking system (ABS) configured to perform the braking of the vehicle; a motor driven power steering (MDPS) configured to perform the steering of the vehicle; a CAN network configured to communicate with a human machine interface (HMI) configured to display the state of the vehicle to a driver; a shift lever configured to shift the gears of the vehicle; an acceleration pedal configured to accelerate the vehicle and a brake pedal configured to brake the vehicle; a smart control unit (SCU) configured to intercommunicate over the CAN network, equipped with a LIN network that processes operation signals of an ASCC button and preceding vehicle detection signals of front and rear sensors, and configured such that advanced smart cruise control designed to secure traveling safety without the operation of the driver during traveling via intercommunication using the CAN network; and a vehicle control unit (VCU) configured to intercommunicate over the CAN network, equipped with an management algorithm that controls the torque of the motor in an advanced smart cruise control mode in which regenerative braking is implemented according to a battery voltage level without the operation of the driver in deceleration intended to maintain an inter-vehicle distance to a preceding vehicle during the execution of advanced smart cruise control, and configured to control the vehicle at the highest level.

### RELATED ART DOCUMENTS

### Patent Documents

Patent document 1: Korean Unexamined Patent Application No. 10-2013-0130217

Patent document 2: Korean Unexamined Patent Application No. 10-2013-0142349

Patent document 3: Korean Unexamined Patent Application No. 10-2014-0089800

Patent document 4: Korean Unexamined Patent Application No. 10-2015-0056368

### SUMMARY

The present invention has been conceived to overcome the above-described problems, and an object of the present invention is to provide an electric vehicle which is equipped with separate drive motors based on first gear shifting, second gear shifting, third gear shifting and fourth gear shifting that allow the vehicle to travel at appropriate speeds according to gear shifting.

Another object of the present invention is to provide an electric vehicle in which gear shifting is performed in different drive units according to the traveling speed of the vehicle.

In order to accomplish the above objects, the present invention provides an electric vehicle equipped with a battery, the electric vehicle including: a first gear shifting unit configured to allow gear shifting for a low speed to be performed; a second gear shifting unit configured to allow gear shifting for a high speed to be performed; and a rotation shaft configured to be rotated by the driving of the first and second gear shifting units.

The electric vehicle may further include a power supply unit configured to supply power to the first and second gear shifting units.

The first gear shifting unit may include a first drive gear unit configured to allow the electric vehicle to travel at a low speed, and a second drive gear unit configured to allow the electric vehicle to travel at a low speed; the first drive gear unit may include a first gear coupled over the rotation shaft, a first motor installed on the first gear to rotate the first gear, a second gear engaged with one side of the first gear, a second motor installed on the second gear to rotate the second gear, a third gear engaged with a remaining side of the first gear, and a third motor installed on the third gear to rotate the third gear; and the second drive gear unit may include a fourth motor installed on the first gear to rotate the first gear, and a fifth motor installed on the third gear to rotate the third gear.

The second gear shifting unit may include a third drive gear unit configured to allow the electric vehicle to travel at a high speed, and a fourth drive gear unit configured to allow the electric vehicle to travel at a high speed; the third drive gear unit may include a first gear coupled over the rotation shaft, a second gear engaged with one side of the first gear, a first motor installed on the second gear to rotate the second gear, a third gear engaged with the other side of the first gear, and a second motor installed on the third gear to rotate the third gear; and the fourth drive gear unit may include a third motor installed on the second gear to rotate the second gear, and a fourth motor installed on the third gear to rotate the third gear.

The power supply unit may include: a first gear installed to be rotatable by the first motor; a second gear installed to be rotatable by the first motor; a third gear engaged with the first and second gears; a power generator configured to generate power while being rotated by the third gear; and a plurality of batteries configured to be charged with power generated by the power generator.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a schematic block diagram showing an electric vehicle according to one embodiment of the present invention; and

FIG. 2 is a schematic block diagram showing an electric vehicle according to another embodiment of the present invention.

### DETAILED DESCRIPTION

Electric vehicles according to embodiments of the present invention will be described in detail with reference to the accompanying drawings below.

An electric vehicle according to one embodiment of the present invention is an electric vehicle equipped with a battery, and includes a first gear shifting unit 100 configured to allow gear shifting for a low speed to be performed, a second gear shifting unit 200 configured to gear shifting for a high speed to be performed, and a rotation shaft 300 configured to be rotated by the driving of the first and second gear shifting units 100 and 200.

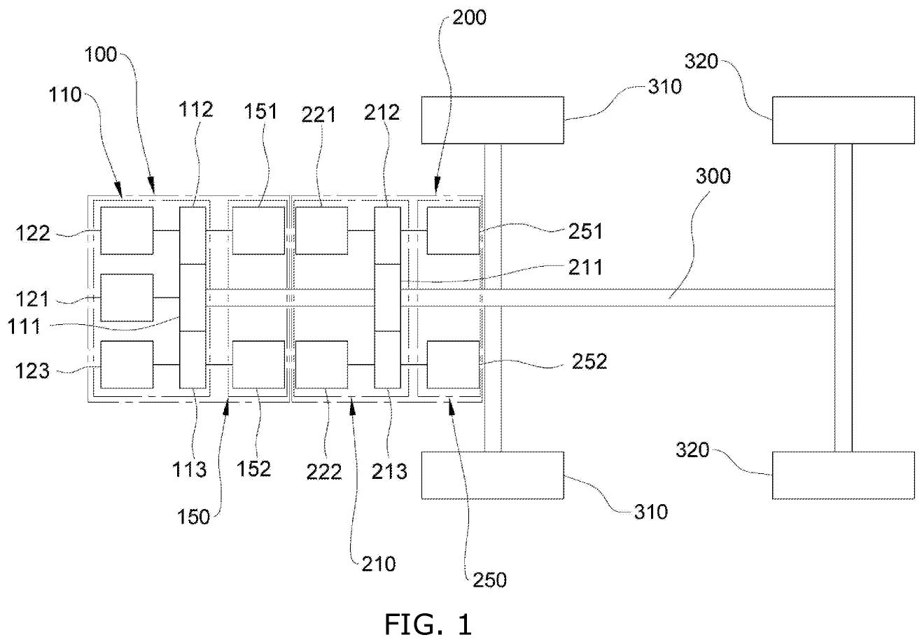

FIG. 1 is a schematic block diagram showing an electric vehicle according to one embodiment of the present invention.

As shown in FIG. 1, the electric vehicle according to the embodiment of the present invention performs gear shifting according to the traveling speed of the vehicle, and includes the first gear shifting unit 100 configured to allow traveling to be performed at a low speed and the second gear shifting unit 200 configured to allow traveling to be performed at a high speed.

The first gear shifting unit 100 includes a first drive gear unit 110 configured to allow the electric vehicle to travel at a low speed and a second drive gear unit 150 configured to allow the electric vehicle to travel at a low speed.

The first drive gear unit 110 includes a first gear 111 configured to be coupled over the rotation shaft 300, a first motor 121 installed on the first gear 111 to rotate the first gear 111, a second gear 112 engaged with one side of the first gear 111, a second motor 122 installed on the second gear 112 to rotate the second gear 112, a third gear 113 engaged with the other side of the first gear 111, and a third motor 123 installed on the third gear 113 to rotate the third gear 113.

The second drive gear unit 150 includes a fourth motor 151 installed on the first gear 111 to rotate the first gear 111 and a fifth motor 152 installed on the third gear 113 to rotate the third gear 113.

The first drive gear unit 110 and the second drive gear unit 150 are driven in the case of low-speed traveling. The first drive gear unit 110 is the lowest gear-shifting stage and corresponds to a first gear-shifting unit, and the second drive gear unit 150 corresponds to a second gear-shifting unit so that the first drive gear unit 110 allows the vehicle to travel at a higher speed than the first drive gear unit 110. The first gear 111 is coupled over the rotation shaft 300, and the first gear 111 rotates the rotation shaft 300.

The second gear 112 configured to rotate the first gear 111 is engaged with one side of the first gear 111, and the third gear 113 configured to rotate the first gear 111 is engaged with the other side of the first gear 111.

The first motor 121 is installed on the first gear 111, the second motor 122 is installed on the second gear 112, and the third motor 123 is installed on the third gear 113.

These first to third motors 121, 122 and 123 rotate the first gear 111, the second gear 112 and the third gear 113, respectively, and the rotation shaft 300 is rotated as the gears 111, 112 and 113 that are driven by these motors 121, 122 and 123 are rotated.

The first motor 121, the second motor 122, and the third motor 123 are configured to obtain a large amount of power.

As the three motors 121, 122 and 123 are driven, torque is obtained. This is intended to enable smooth traveling along an inclined road or the like.

The second drive gear unit 150 includes the fourth motor 151 configured to rotate the second gear 112 and the fifth motor 152 configured to rotate the third gear 113.

Since the second drive gear unit 150 requires a higher rotational speed than the first drive gear unit 110, the second drive gear unit 150 is rotated at a higher rotational speed.

Accordingly, the second drive gear unit 150 allows the vehicle to travel at a higher speed than the first drive gear unit 110.

The second gear shifting unit 200 includes a third drive gear unit 210 configured to allow the electric vehicle to travel at a high speed and a fourth drive gear unit 250 configured to allow the electric vehicle to travel at a high speed.

The third drive gear unit 210 includes a first gear 211 coupled over the rotation shaft, a second gear 212 engaged with one side of the first gear 211, a first motor 221 installed on the second gear 212 to rotate the second gear 212, a third gear 213 engaged with the other side of the first gear 211, and a second motor 222 installed on the third gear 213 to rotate the third gear 213.

The fourth drive gear unit 250 includes a third motor 251 installed on the second gear 212 to rotate the second gear 212 and a fourth motor 252 installed on the third gear 213 to rotate the third gear 213.

The second gear shifting unit 200 allows the vehicle to travel at a higher speed than the first gear shifting unit 100. The second gear shifting unit 200 includes the third drive gear unit 210 configured to be rotated at a higher speed than the second drive gear unit 150 and the fourth drive gear unit 250 configured to be rotated at a higher speed than the third drive gear unit 210.

The third drive gear unit 210 includes the first gear 211 installed over the rotation shaft 300, the second gear 212 engaged with one side of the first gear 211, the third gear 213 engaged with the other side of the first gear 211, the first motor 221 installed on one side of the second gear 212, and the second motor 222 installed on one side of the third gear 213.

In addition, the fourth drive gear unit 250 includes the third motor 251 installed on the other side of the second gear 212 and the fourth motor 252 installed on the other side of the third gear 213.

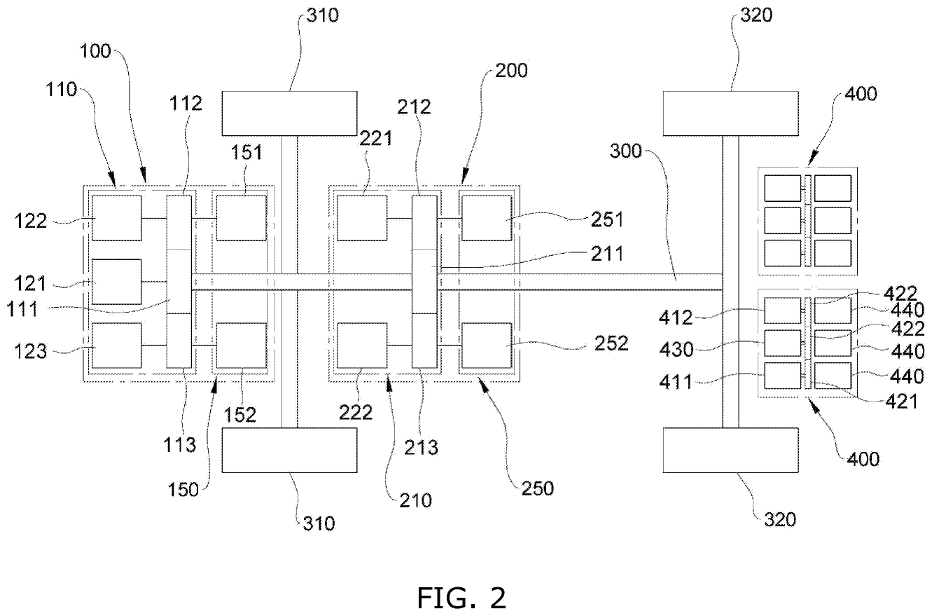

FIG. 2 is a schematic block diagram showing an electric vehicle according to another embodiment of the present invention.

As shown in FIG. 2, the electric vehicle according to the other embodiment of the present invention includes a first gear shifting unit 100 including a first drive gear unit 110 and a second drive gear unit 150, and a second gear shifting unit 200 including a third drive gear unit 210 and a fourth drive gear unit 250.

The first gear shifting unit 100 is installed on the front of the rotation shaft 300, and the second gear shifting unit 200 is installed on the rotation shaft 300 to be spaced apart from the first gear shifting unit 100.

Since the first gear shifting unit 100 and the second gear shifting unit 200 are the same as those of the above-described embodiment, redundant descriptions thereof will be omitted.

Meanwhile, the power supply unit 400 includes a first gear 421 installed to be rotatable by a first motor 411, a second gear 422 installed to be rotatable by the first motor 411, a third gear 423 engaged with the first gear 421 and the second gear 422, a power generator 430 configured to generate power while being rotated by the third gear 423, and a plurality of batteries 440 configured to be charged with power generated by the power generator 430.

The first gear 421 is connected to the first motor 411, the second gear 422 is connected to the second motor 412, and the third gear 423 is connected between the first gear 411 and the second gear 412.

The power generator 430 configured to generate power is installed on the third gear 423, and the plurality of batteries 400 configured to be charged with power generated by the power generator 430.

The third gear 423 drives the power generator 430 while being rotated by the first gear 421 or the second gear 422, the battery 440 is charged with power generated by the power generator 430, and the power is supplied to the first gear shifting unit 100 and the second gear shifting unit 200.

Next, a method of operating an electric vehicle according to one embodiment of the present invention will be described with reference to FIGS. 1 and 2.

As shown in FIGS. 1 and 2, the first gear shifting unit 100 is driven to allow the vehicle to travel at a low speed, and the first drive gear unit 110 is driven by applied power.

The first motor 121, the second motor 122, and the third motor 123 are driven by applied power, and drive the first gear 111, the second gear 112 and the third gear 113, respectively, and finally rotate the rotation shaft 300 coupled to the first gear 111.

The rotation shaft 300 rotates a front wheel 310 and a rear wheel 320, thereby enabling the vehicle to travel.

Meanwhile, as the speed of the electric vehicle increases, the second drive gear unit 150 is driven, and the fourth motor 151 and the fifth motor 152 are driven and rotate the second gear 112 and the third gear 113.

The first gear 111 is rotated by the second gear 112 and the third gear 113, and accordingly the rotation shaft 300 is driven. The second drive gear unit 150 allows the vehicle to travel at a higher speed than the first drive gear unit 110.

In the third drive gear unit 210 of the second gear shifting unit 200, the second gear 212 is rotated by the first motor 221, and the second gear 213 is rotated by the second motor 222.

Accordingly, the first gear 211 installed between the second gear 212 and the third gear 213 is rotated and rotates the rotation shaft 300, and thus the rotation shaft 300 is driven. The third drive gear unit 210 is rotated at a higher speed than the second drive gear unit 150, and allows the vehicle to travel at a higher speed than the second drive gear unit 150.

In addition, the third motor 251 and fourth motor 252 of the fourth drive gear unit 250 drive the second gear 212 and the third gear 213 with applied power, rotate the first gear 211, and finally drive the rotation shaft 300.

The third drive gear unit 210 is rotated at a higher speed than the second drive gear unit 150, and the fourth drive gear unit 250 is rotated at a higher speed than the third drive gear unit 210.

Meanwhile, it will be apparent that not only the first gear shifting unit 100 and the second gear shifting unit 200 but also a third gear shifting unit (not shown) and a fourth gear shifting unit (not shown) may be installed on the rotation shaft 300, thereby enabling a vehicle to travel at higher speeds.

As described above, in accordance with the electric vehicle according to the present invention, effects are achieved in that low-speed traveling is not only enabled by the first and second drive gear units of the first gear shifting unit but high-speed traveling is also enabled by the third and fourth drive gear units of the second gear shifting unit, traveling speed can be increased and decreased by adding a plurality of gear shifting units to the rotation shaft, and power generated by the power supply unit can be continuously supplied and thus the vehicle can travel for a long time.

While the present invention has been described in conjunction with the embodiments specifically, the present invention is not limited to the embodiments, and various modifications may be made without departing from the spirit of the invention.

What is claimed is:

1. An electric vehicle equipped with a battery, the electric vehicle comprising:
a first gear shifting unit configured to allow gear shifting for a low speed to be performed;
a second gear shifting unit configured to allow gear shifting for a high speed to be performed; and
a rotation shaft configured to be rotated by driving of the first and second gear shifting units;
wherein the first gear shifting unit comprises:
a first drive gear unit configured to allow the electric vehicle to travel at a low speed; and
a second drive gear unit configured to allow the electric vehicle to travel at a low speed;
wherein the first drive gear unit comprises:
a first gear coupled over the rotation shaft;
a first motor installed on the first gear to rotate the first gear;
a second gear engaged with one side of the first gear;
a second motor installed on the second gear to rotate the second gear;
a third gear engaged with a remaining side of the first gear; and
a third motor installed on the third gear to rotate the third gear; and
wherein the second drive gear unit comprises:
a fourth motor installed on the first gear to rotate the first gear; and
a fifth motor installed on the third gear to rotate the third gear.

2. The electric vehicle of claim 1, further comprising a power supply unit configured to supply power to the first and second gear shifting units.

3. The electric vehicle of claim 1, wherein:
the second gear shifting unit comprises;
a third drive gear unit configured to allow the electric vehicle to travel at a high speed; and
a fourth drive gear unit configured to allow the electric vehicle to travel at a high speed;
the third drive gear unit comprises:
a first gear coupled over the rotation shaft;
a second gear engaged with one side of the first gear;
a first motor installed on the second gear to rotate the second gear;
a third gear engaged with a remaining side of the first gear; and
a second motor installed on the third gear to rotate the third gear; and
the fourth drive gear unit comprises:
a third motor installed on the second gear to rotate the second gear; and
a fourth motor installed on the third gear to rotate the third gear.
